(19) United States
(12) Patent Application Publication
(10) Pub. No.: US 2015/0041041 A1
(43) Pub. Date: Feb. 12, 2015

(54) MANUFACTURING MILLWORK COMPONENTS

(71) Applicant: Woodgrain Millwork, Inc., Fruitland, ID (US)

(72) Inventors: Reed N. Dame, Ontario, OR (US); Jerry Michael Hardin, Nampa, ID (US)

(73) Assignee: Woodgrain Millwork, Inc., Fruitland, ID (US)

(21) Appl. No.: 13/960,770

(22) Filed: Aug. 6, 2013

(51) Int. Cl. B05D 7/06

(52) U.S. Cl. CPC B05D 7/06
USPC 156/60; 427/289

(57) ABSTRACT

A method of manufacturing moulding and like finishing strips or other types of millwork components. An embodiment of the present disclosure includes manufacturing an intermediate component strip having multiple profile faces. The intermediate component may be coated with a primer or paint coating. Following the coating application, the intermediate component may undergo a sanding operation. After the coating application, the intermediate component may undergo a sawing operation, thereby resulting in multiple strips, each strip comprising a profile face. In embodiments of the present disclosure, two or more lobes are joined by a thin web, each lobe comprising one or more profile faces. In a sawing operation, each lobe may be divided and the web may be removed, resulting in multiple strips, each strip comprising a profile face.

### BACKGROUND

1. Technical Field

The present disclosure relates generally to the manufacture of millwork components. In particular, the present disclosure relates to manufacturing processes for moulding strips and other trim and/or finishing strips.

2. Description of Related Art

Typically, moulding and other types of finishing strips are manufactured in processes that include milling and/or shaping the component to its final shape, applying primer to the component, and drying the primer in a drying oven or similar apparatus. In some circumstances, a labeling machine applies a label to each primed component to facilitate subsequent tracking and distribution. Various manufacturing processes may be carried out in semi-autonomous steps assisted by a human operator, for example by placing intermediate millwork components in a designated position and/or orientation on a conveyor or other feeder apparatus. Common objectives amongst manufacturers of millwork strips include increasing product throughput of manufacturing processes and decreasing raw material waste. Realizing such objectives may decrease per-unit manufacturing cost, decrease labor costs, and increase overall production, therefore increasing overall profits.

### SUMMARY

In one embodiment, a method for manufacturing a millwork component is disclosed. The method includes applying a coating to an intermediate component and sawing the coated intermediate component into multiple millwork strips. The intermediate component is a strip having at least two profile faces. Each of the multiple millwork strips has one of the profile faces.

In another embodiment, a method of preparing a moulding strip is disclosed. The method includes moulding an intermediate component and sawing the intermediate component into multiple moulding strips. The intermediate component includes at least two profile faces and a cross section having at least one lobe. Each of the multiple moulding strips has one of the profile faces.

In another embodiment, an intermediate millwork component is disclosed. The intermediate millwork component comprises a strip that has at least two profile faces and a coating.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the disclosure to those skilled in the art. Non-limiting and non-exhaustive embodiments of the present disclosure are described with reference to the following figures, wherein like reference numerals refer to like parts throughout the various views unless otherwise specified.

### BRIEF DESCRIPTION OF THE FIGURES

Non-limiting and non-exhaustive embodiments of the present disclosure are described with reference to the following figures, wherein like reference numerals refer to like parts throughout the various views unless otherwise specified.

FIG. 1 depicts a perspective view of an intermediate millwork component for manufacturing four quarter round moulding components according to an embodiment of the present disclosure;

FIG. 2 depicts an end view of an intermediate millwork component for manufacturing four quarter round moulding components according to an embodiment of the present disclosure;

FIG. 3 depicts a primer operation of an intermediate millwork component for manufacturing four quarter round moulding components according to an embodiment of the present disclosure;

FIG. 4 depicts a sawing operation of an intermediate millwork component for manufacturing four quarter round moulding components according to an embodiment of the present disclosure;

FIG. 5 depicts quarter round moulding components manufactured according to an embodiment of the present disclosure;

FIG. 6 depicts a perspective view of an intermediate millwork component for manufacturing four shoe moulding components according to an embodiment of the present disclosure;

FIG. 7 depicts an end view of an intermediate millwork component for manufacturing four shoe moulding components according to an embodiment of the present disclosure;

FIG. 8 depicts a primer operation of an intermediate millwork component for manufacturing four shoe moulding components according to an embodiment of the present disclosure;

FIG. 9 depicts a sawing operation of an intermediate millwork component for manufacturing four shoe moulding components according to an embodiment of the present disclosure;

FIG. 10 depicts shoe moulding components manufactured according to an embodiment of the present disclosure;

FIG. 11 depicts a perspective view of an intermediate millwork component for manufacturing two quarter round moulding components according to an embodiment of the present disclosure;

FIG. 12 depicts an end view of an intermediate millwork component for manufacturing two quarter round moulding components according to an embodiment of the present disclosure;

FIG. 13 depicts a primer operation of an intermediate millwork component for manufacturing two quarter round moulding components according to an embodiment of the present disclosure;

FIG. 14 depicts a sawing operation of an intermediate millwork component for manufacturing two quarter round moulding components according to an embodiment of the present disclosure;

FIG. 15 depicts a sanding operation of an intermediate millwork component for manufacturing two quarter round moulding components according to an embodiment of the present disclosure; and

FIG. 16 depicts a sanding operation of an intermediate millwork component for manufacturing four quarter round moulding components according to an embodiment of the present disclosure.

Corresponding reference characters indicate corresponding components throughout the several views of the drawings Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments of the present disclosure comprise methods of applying primer or similar coating to an intermediate millwork component prior to a sawing operation on the intermediate component. In the present disclosure, reference to “millwork component” may include moulding strips, also commonly known as molding or coving, or other types of finishing strips and/or millwork components. Such millwork components may be manufactured from wood, reformed or engineered wood, plastic, plaster, composites thereof, or other materials.

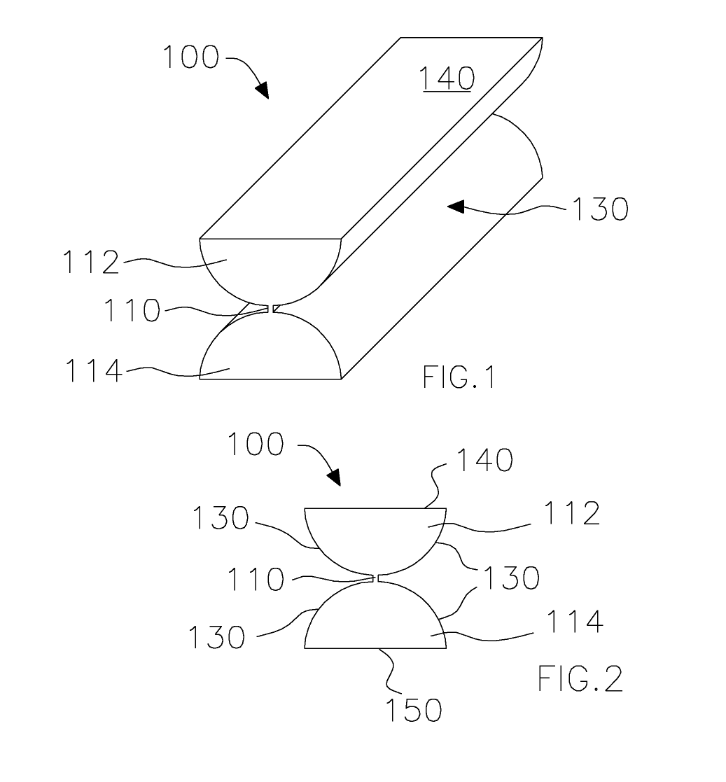

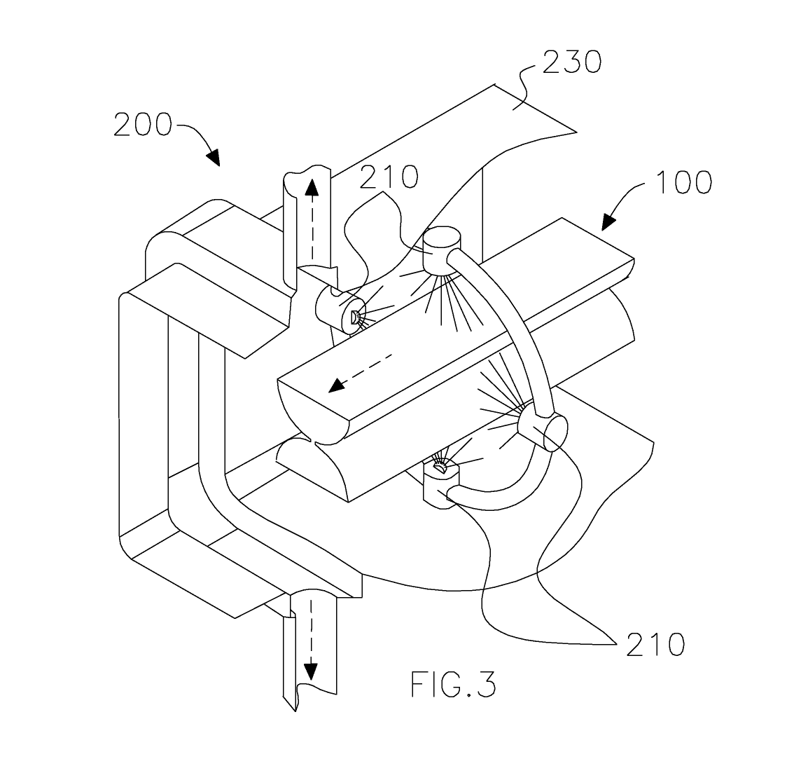

Referring now to FIG. 1, intermediate component 100 is manufactured in a milling or shaping operation. Embodiments of intermediate component 100 comprise an hourglass-shaped cross section. Intermediate component 100 comprises thin web 110 connecting top lobe 112 and bottom lobe 114. Each lobe 112, 114 comprises a hemispherical cross section and further comprises curved profile face 130. In operation, intermediate component 100 may be produced as part of a manufacturing operation to manufacture multiple quarter round strips, each carrying a profile face 130, as will be described in further detail. In embodiments, intermediate component 100 is manufactured by a moulder with dual profile cutters. The cutters may be selectively horizontal-facing, resulting in a top-bottom lobe 112, 114 orientation as depicted in FIGS. 1 and 2. Alternatively, the cutters may be vertical-facing, resulting in a side-to-side lobe orientation. As would be understood by one of ordinary skill in the art having the benefit of this disclosure, relatively precise alignment of cutters may ensure that opposing surfaces of web 110 are substantially vertically and horizontally aligned and centered. Web 110 may be made large enough to allow sufficient separation of lobes 112, 114, thereby resulting in satisfactory coverage of primer or other coating on profile faces 130 in a subsequent primer application that will be described in further detail. Web 110 may be made thin enough to fall within the tolerance of a rotary saw that will be used in a subsequent sawing operation, as will be described in further detail.

Referring to FIG. 2, profile faces 130 match a selected profile for a completed quarter round strip. Intermediate component 100 comprises substantially flat top surface 140 and bottom surface 150. In embodiments, intermediate component 100 is manufactured by milling material from a stock piece having a rectangular cross section. In alternative embodiments, intermediate component 100 can be manufactured using other methods known in the art. For example, a plastic intermediate component 100 may be manufactured using known extrusion or molding methods.

Referring to FIG. 3, intermediate component 100 may be fed into primer applicator 200. In embodiments, primer applicator 200 comprises spray heads 210 inside spray housing 230. Spray heads 210 can apply primer to surfaces 130, 140, 150. In embodiments, primer is applied only to profile faces 130, for example by a primer applicator comprising only two horizontal spray heads directed at profile faces 130. Spray heads 210 may be directed toward web 110 to adequately coat profile faces 130, including the regions near web 110 where opposing surfaces from each lobe 112, 114 define a relatively narrow space. In alternative embodiments, primer is applied to intermediate component 100 by a vacuum coater. Additional coating methods fall under the scope of the present disclosure.

Following primer application to intermediate component 100, the primer may be allowed to dry. Embodiments of the present disclosure comprise use of a drying oven to dry and/or cure the applied primer on intermediate component 100. Alternatively, intermediate component 100 may be air-dried or dried using other methods.

Labels 120 may be affixed to intermediate component 100 after the primer application step. In embodiments, a label 120 comprises an adhesive with a bar code or other identifier that may facilitate item tracking for distribution, product stocking, and/or sales purposes. Labels 120 may be affixed side-by-side on each of surfaces 140 and 150 so that each quarter round strip 160 (depicted in FIG. 5) carries a label 120. Labels 120 may be applied by a label machine as is already known in the art. In alternative embodiments, other types of markings may be applied to intermediate component 100. For example, bar code or other identifying symbols may be printed, etched, burned, or otherwise marked directly on surfaces 140, 150.

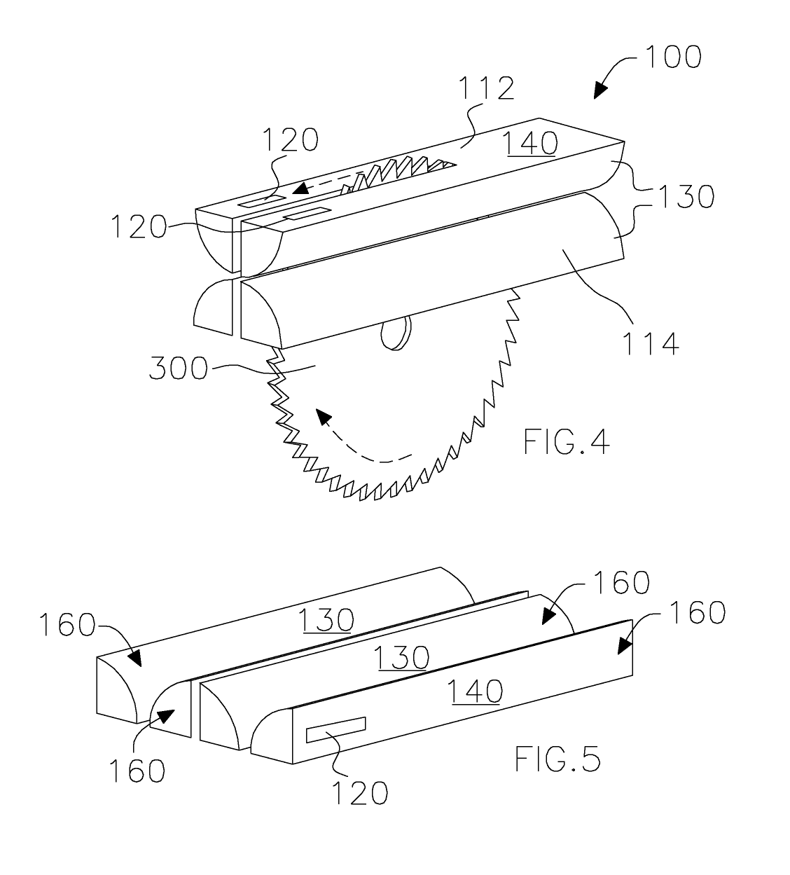

Referring now to FIG. 4, intermediate component 100 is fed into circular saw 300 for a cutting operation. Saw 300 cuts intermediate component 100 into four quarter circle strips 160 by removing web material 110 and bisecting each lobe 112, 114. As would be understood by one of ordinary skill in the art having the benefit of this disclosure, web 110 is thinner than the blade of saw 300, such that most or all material of web 110 is removed by the sawing operation. A precise placement of intermediate component 100 at saw 300 may be facilitated by movement of intermediate component 100 upon rollers and/or within a guide channel leading to saw 300 to position intermediate component 100 such that saw 300 cuts through the center of intermediate component 100. Plastic fences may also be used to guide intermediate component 100 to saw 300. Such fences may comprise ultra-high-molecular-weight polyethylene (which may be commonly known as “UHMW”) or like nonabrasive substances to mitigate scuffing of the recently-primed surfaces.

By maintaining sufficiently tight tolerances for the thickness and placement of web 110 and placement of intermediate component 100 relative to saw 300, substantially all web 110 material may be removed from moulding strips 160. As depicted in FIG. 5, intermediate component 100 has been cut into four quarter round strips 160 having a profile face 130. In embodiments, each strip 160 carries a label 120 that was applied prior to the sawing operation.

Embodiments of the present disclosure may include moulding intermediate components from raw stock having virtually any desired thickness and/or length. Example embodiments may be produced from 4/4 (1-inch thick), 5/4 (1.25-inch thick), or 6/4 (1.5-inch thick) raw stock. Alternatively, intermediate components may be produced from raw stock having other selected dimensions to result in intermediate components of any desired size.

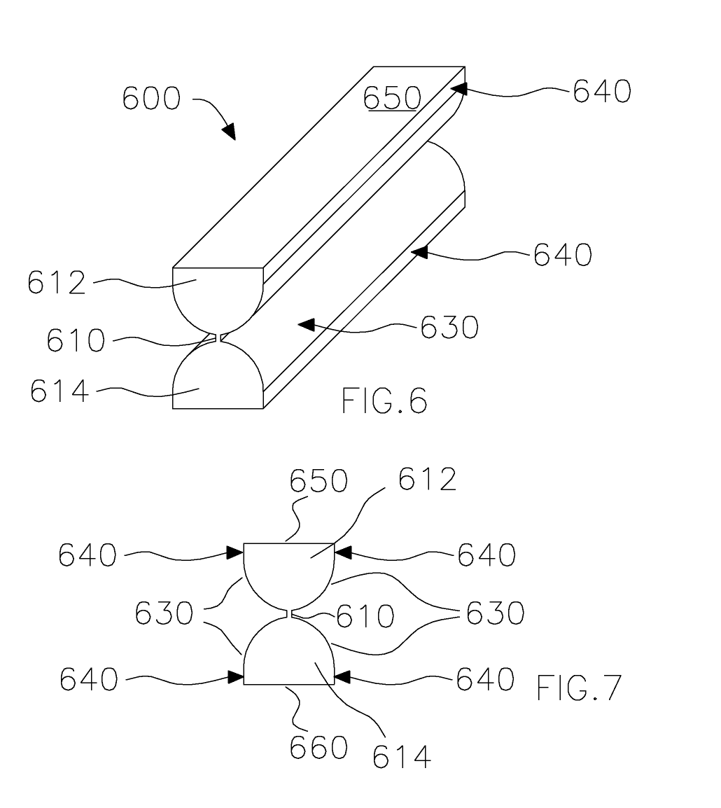

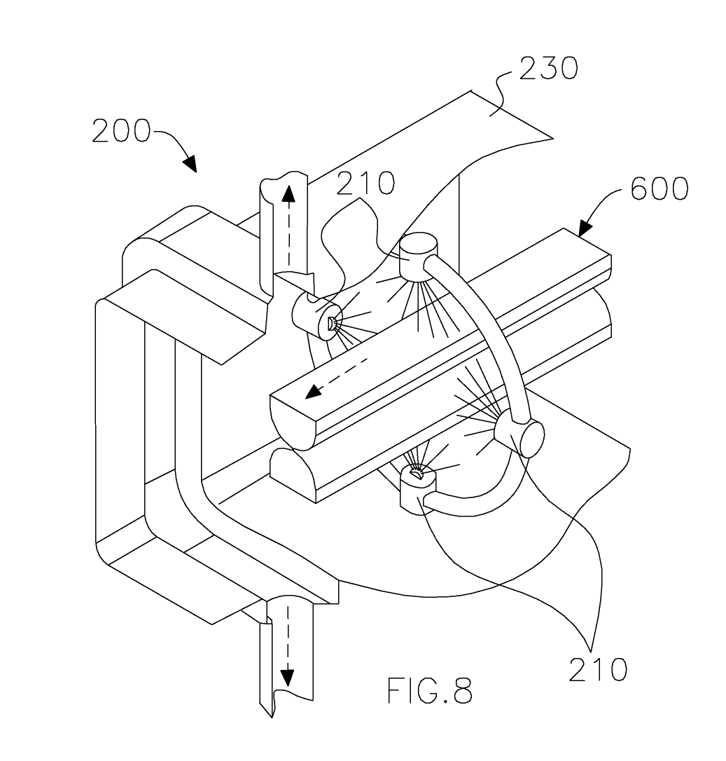

Referring to FIGS. 6 and 7, in embodiments of the present disclosure, intermediate component 600 is manufactured in a moulding machine or other type of milling or shaping operation. Intermediate component 600 comprises a cross section having top lobe 612 and bottom lobe 614 joined by web 610. Each lobe 612, 614 has profile faces 630, including relatively flat section 640. Intermediate component 600 further comprises substantially flat top surface 650 and bottom surface 660. Referring now to FIG. 8, intermediate component 600 may be given a primer application at applicator 200 similar to the operation described above. Labels 120 may be applied to intermediate component 600 following the coating operation.

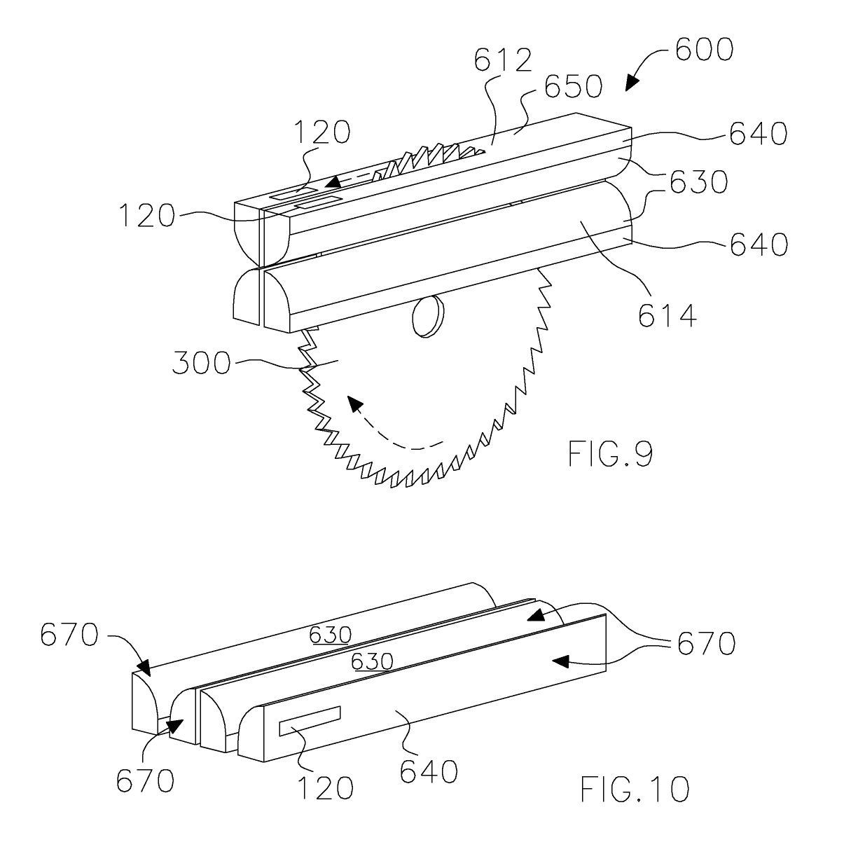

Referring to FIG. 9, intermediate component 600 is depicted in the sawing operation at saw 300. By positioning intermediate component 600 so that web 610 is substantially removed by saw 300, resulting strips 670 are created having a shoe profile face, as depicted in FIG. 10.

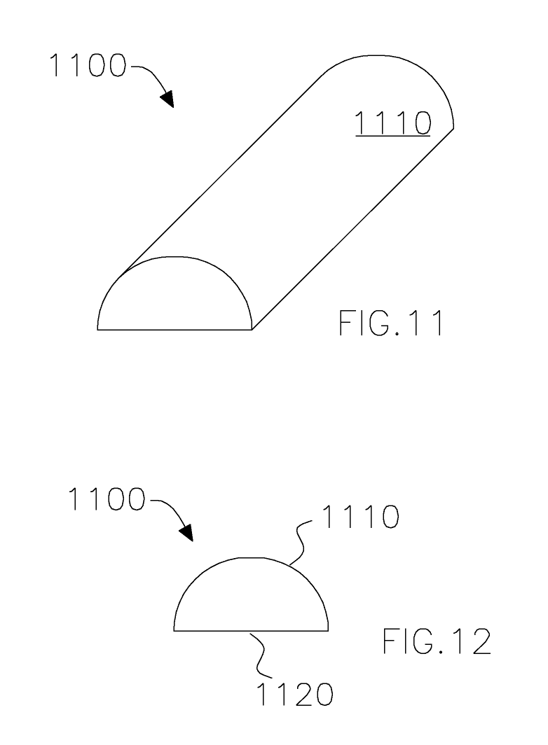

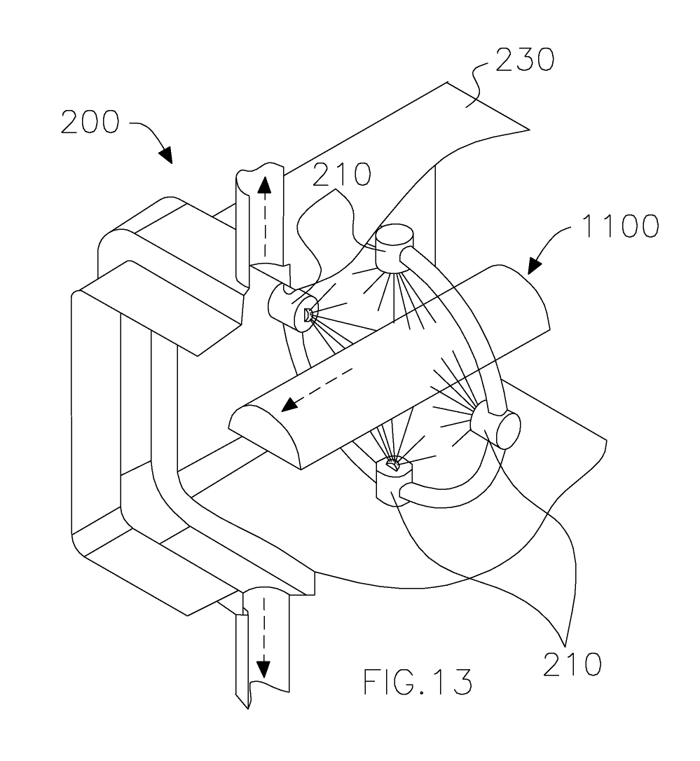

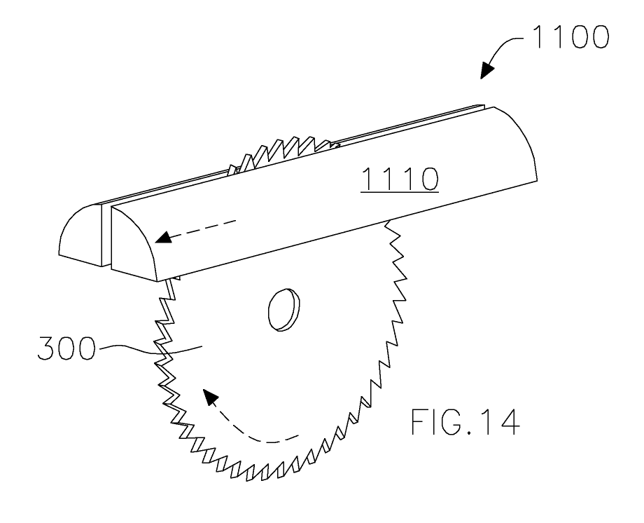

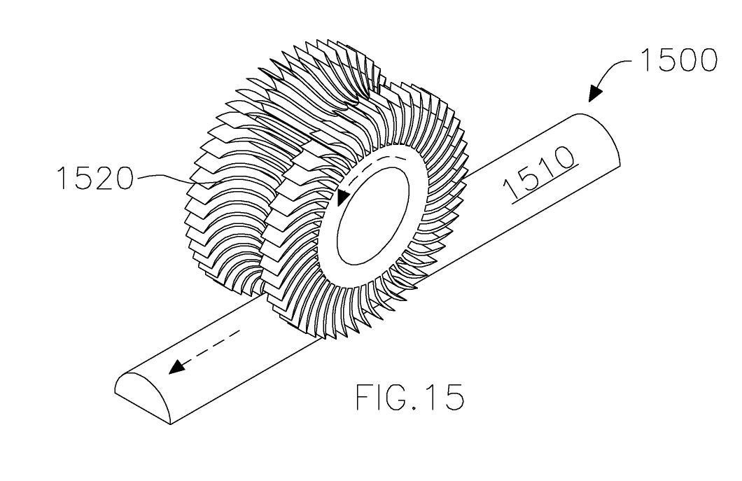

Referring to FIGS. 11-14, an alternative method of manufacturing quarter round strips is depicted. Similar to the method described above, intermediate component 1100 comprises a hemispherical cross section having curved profile face surface 1110 and flat bottom 1120. Intermediate component 1100 may undergo coating, labeling, and sawing operations as described above, resulting in two quarter round strips 160. Each quarter round strip 160 has a profile face surface 1110.

It should be understood that the foregoing descriptions of processes for manufacturing quarter round strips 160 and shoe strips 670 are exemplary embodiments and not to be taken in a limiting sense. As such, embodiments of the present disclosure may include manufacture of strips having virtually any size, shape, profile, and/or length. In general, strips of a desired profile may be manufactured by creating an intermediate component having a cross section with the desired profile face. Typically, such intermediate components may exhibit bilateral or multilateral symmetry to result in matching strips. As an additional example, if a strip having a concave profile is desired, such as in a cavetto moulding strip, an intermediate component comprising one or more lobes having inverted curved profile faces may be manufactured. Multiple lobes may be connected by thin webs.

Alternatively, an intermediate component having a nonsymmetrical cross section may be desired to result in moulding strips having profiles different from each other. For example, an intermediate component having a quarter round profile face and a cavetto profile face may be divided to create the two moulding strips having different profiles.

In alternative embodiments, more than four strips may be manufactured from a single intermediate component that has a cross section with more than two lobes, where the lobes are connected by multiple webs. For example, an intermediate component strip having a cross section with three vertically-stacked lobes, the lobes being connected by webs, may result in six strips after a sawing operation. In this way, virtually any number of moulding strips may be manufactured.

In alternative embodiments of the present disclosure, paint is applied to an intermediate component after or instead of a primer application. It is to be understood that any similar coating and/or multiple coatings may be applied to intermediate components before and/or after a sawing operation.

Referring now to FIG. 15, embodiments of the present disclosure comprise a sanding operation carried out on intermediate component 1500. In embodiments, intermediate component 1500 is sanded after a coating application and drying step. In other embodiments, sanding operation is carried out on an uncoated intermediate component. In embodiments, sanding operation is carried out prior to a sawing operation. Sanding head 1520 comprises sanding blades radially arranged around a rotating disc. The sanding blades of head 1520 define a sanding profile that corresponds to the profile surface 1510 of intermediate component 1500.

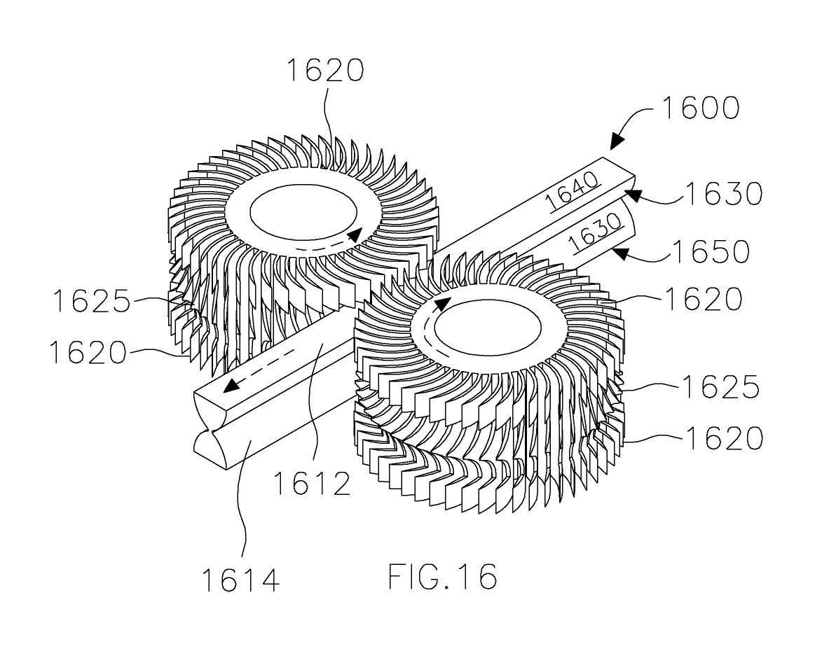

Referring now to FIG. 16, intermediate component 1600 may be sanded by sanding heads having multiple sanding profiles 1620, 1625 defined by the shape of the sanding blades. Radius profiles 1625 of sanding heads can correspond to profile faces 1630 of intermediate component 1600 and flat profiles 1620 of sanding heads can correspond to flat surfaces 1640, 1650 of intermediate component 1600. Sanding profiles 1625 may be positioned relative to each other so as to leave a web of sufficient thickness between lobes 1612, 1614 of intermediate component 1600. In various embodiments, a sanding operation may be carried out prior to application of labels 120 to intermediate components. In other embodiments, one or more sanding or buffing operations may be carried out by other means.

Embodiments of the present disclosure may present several advantages over prior art methods. For example, utilizing methods disclosed herein, multiple millwork components may be manufactured in the same amount of time that traditional methods could only manufacture a single component, thereby increasing overall production. Embodiments of the present disclosure may further result in reduced manufacturing cost by reducing waste of raw material and reducing labor-related costs.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A method for manufacturing a millwork component, comprising:
applying a coating to an intermediate component, wherein the intermediate component comprises a strip having at least two profile faces, thereby resulting in a coated intermediate component; and
sawing the coated intermediate component into multiple millwork strips, wherein each of the multiple millwork strips comprises one of the at least two profile faces.

2. The method of claim 1, wherein the intermediate component comprises a cross sectional-shape comprising two lobes connected by a web.

3. The method of claim 2, wherein sawing the coated intermediate component comprises:
removing the web and
dividing the two lobes.

4. The method of claim 2, wherein sawing the coated intermediate component further comprises:
aligning the web with a saw blade and
maneuvering the coated intermediate component toward the saw blade.

5. The method of claim 1, further comprising applying multiple labels to the coated intermediate component.

6. The method of claim 5, wherein the label comprises an adhesive label.

7. The method of claim 5, wherein the label comprises a printed label.

8. The method of claim 1, wherein the coating comprises a primer application.

9. The method of claim 1, further comprising sanding the coated intermediate component.

10. A millwork component manufactured by the method of claim 1.

11. A method of preparing a moulding strip, comprising:
moulding an intermediate component, wherein the intermediate component comprises:
at least two profile faces; and
a cross section having at least one lobe; and
sawing the intermediate component into multiple moulding strips, wherein each of the multiple moulding strips comprises one of the at least two profile faces.

12. The method of claim 11, further comprising applying multiple labels to the intermediate component.

13. The method of claim 12, wherein the label comprises an adhesive label.

14. The method of claim 12, wherein the label comprises a printed label.

15. The method of claim 11, wherein sawing the intermediate component into multiple moulding strips comprises dividing the at least one lobe.

16. An intermediate millwork component, comprising:
a strip further comprising at least two profile faces and
a coating.

17. The intermediate millwork component of claim 16, further comprising a web joining at least two lobes.
